(19) United States
(12) Patent Application Publication
(10) Pub. No.: US 2026/0001575 A1
(43) Pub. Date: Jan. 1, 2026

(54) MOBILE POWER SYSTEM

(71) Applicant: American Superconductor Corporation, Ayer, MA (US)

(72) Inventors: John M. Ulliman, McLean, VA (US); Michael P. Ross, Leominster, MA (US)

(21) Appl. No.: 18/756,390

(22) Filed: Jun. 27, 2024

(51) Int. Cl. B61C 13/00; B61C 7/04; H02B 1/20; H02B 1/26

(52) U.S. Cl. CPC B61C 13/00; B61C 7/04; H02B 1/202; H02B 1/26

(57) ABSTRACT

A mobile power system configured to be transported on a vehicle for supplying temporary electric power to a remote electric power system. The mobile power system includes a plurality of containers configured to be transported on the vehicle. There is a power generator contained in a faraday enclosure in a first container of the plurality of containers; and a power cable configured to be electrically interconnected to the power generator at a first end and configured to be electrically interconnected to the electric power system at a second end. The power cable contained in a faraday enclosure of a second container of the plurality of containers.

### TECHNICAL FIELD

The present invention relates to a mobile power system, and more particularly to such a mobile power system, which uses high temperature superconductor (HTS) components and which can be used to black-start an electric power system even when the blackout is caused by an extreme electromagnetic incident.

### BACKGROUND ART

Black-start service is important to the safe, reliable, and resilient operation of electric power systems and a critical part of system restoration for electric power grids. Black start is the ability to restart parts of the power system to recover from a blackout. This entails isolated power stations being started individually and gradually reconnected to one another to form an interconnected electric power system again. It is used when the grid experiences a blackout and must be restarted from scratch. As such, black start is a critical resource for maintaining the reliability and resilience of the electric power system and is central to system restoration and recovery plans for system operators.

In large power grids, black-start service typically comes from generators that can be started from an on-site auxiliary generator—without help from external power supplies. For example, a diesel generator may be started with a local battery. This is used to create an AC voltage waveform that other generation sources can synchronize to and start to generate additional power.

One cause of electric power grid blackouts is an extreme electromagnetic incident which may be triggered by an intentional electromagnetic pulse (EMP) attack or a naturally occurring geomagnetic disturbance (GMD), caused by severe space weather. EMPs are associated with intentional attacks using high-altitude nuclear detonations, specialized conventional munitions, or non-nuclear directed energy devices. Effects vary in scale from local to regional to continental, depending upon the specific characteristics of the weapon and the method of attack.

Similarly, extreme GMD events associated with solar coronal mass ejections (when plasma from the sun, with its embedded magnetic field, arrives at Earth) may cause widespread and long-lasting damage to electric power systems and other critical infrastructure. Essentially, any electronics system that is not protected against extreme EMP or GMD events may be subject to either the direct “shock” of the blast itself or to the damage that is inflicted on the systems and controls upon which they are dependent.

### SUMMARY OF THE EMBODIMENTS

In accordance with one embodiment of the disclosure, there is a mobile power system configured to be transported on a vehicle for supplying temporary electric power to a remote electric power system, the mobile power system comprising. The system includes plurality of containers configured to be transported on the vehicle and a power generator contained in a faraday enclosure in a first container of the plurality of containers. There is a power cable configured to be electrically interconnected to the power generator at a first end and configured to be electrically interconnected to the electric power system at a second end; the power cable contained in a faraday enclosure of a second container of the plurality of containers.

In one or more embodiments, the following features may be included. The power generator may be a high temperature superconductor (HTS) generator. The power cable may be a HTS power cable. The plurality of containers may include a third container in which is included a cryogenic cooling system contained in a third faraday enclosure. The cryogenic cooling system may be configured to be fluidly coupled to the HTS power cable and to circulate a cooling fluid in the HTS power cable. The plurality of containers may include a fourth container having a fuel tank configured to be fluidly coupled to a turbine in the second container to supply fuel to the turbine; the turbine contained in the third faraday enclosure and mechanically coupled to the HTS generator. The vehicle may be one of a train or a ship.

In accordance with another embodiment of the disclosure, there is a mobile power system for supplying temporary electric power to an electric power system, the mobile power system. The system includes a plurality of train cars and a locomotive car configured to be interconnected to and propel the plurality of train cars. There is a power generator contained in a faraday enclosure in a first car of the plurality of train cars and a power cable configured to be electrically interconnected to the power generator at a first end and configured to be electrically interconnected to the electric power system at a second end. The power cable is contained in a faraday enclosure of a second car of the plurality of train cars.

In one or more embodiments, the following features may be included. The power generator may be a high temperature superconductor (HTS) generator. The power cable may be a HTS power cable. The plurality of train cars may include a third car in which is included a cryogenic cooling system contained in a third faraday enclosure. The cryogenic cooling system may be configured to be fluidly coupled to the HTS power cable and to circulate a cooling fluid in the HTS power cable. The plurality of train cars may include a fourth car containing a fuel tank configured to be fluidly coupled to a turbine in the second car to supply fuel to the turbine. The turbine may be contained in the third faraday enclosure and mechanically coupled to the HTS generator. The locomotive car may include at least one electronic component contained in a fourth faraday enclosure. There may further be included a fifth car of the plurality of train cars and the fifth car may include a work area for at least one crew member and at least one electronic component contained in a fifth faraday enclosure. Each of the first, second, third, fourth, and fifth faraday enclosures may include four walls, a ceiling, and a floor and wherein one or more of the first, second, third, fourth, and fifth faraday enclosures have the four walls, ceiling, and floor integrated into four walls, ceiling, and floor of its respecting train car. The HTS power cable may be on a spool and may be configured to be unwound to connect the HTS power cable to an electrical connector of a substation of the electric power system. One or more of the first, second, third, fourth, and fifth train cars may include a set of grounding wheels configured to contact the train tracks. Each set of grounding wheels may be retractable and non-load bearing. Each train car with a set of grounding wheels may further include a plurality of sets of load bearing wheels.

### BRIEF DESCRIPTION OF THE DRAWINGS

The foregoing features of embodiments will be more readily understood by reference to the following detailed description, taken with reference to the accompanying drawings, in which:

FIG. 1 is a perspective view of an embodiment of the mobile power system according to an aspect of this disclosure being transported by a train located proximate an electric power substation.

FIG. 2 is a perspective view of the crew berthing and office train car of the train in FIG. 1.

FIG. 3 is a perspective view of the locomotive of the train in FIG. 1.

FIG. 4 is a perspective view of a generic cargo car of the train in FIG. 1.

FIG. 5 is a perspective view of a cargo car of the train including the power cable in FIG. 1.

FIG. 6 is a perspective view of a cargo car of the train including the cooling system in FIG. 1.

FIG. 7 is a perspective view of a cargo car of the train including the generator in FIG. 1.

FIG. 8A is an exploded view of a single-phase high temperature superconductor (HTS) power cable for use with the mobile power system described herein.

FIG. 8B is an exploded view of a three-phase high temperature superconductor (HTS) power cable for use with the mobile power system described herein.

FIG. 9 is a side elevational view of a turbo generator for use with the mobile power system described herein.

FIG. 10 is a cross-sectional view of a HTS generator for use with the mobile power system described herein.

FIG. 11 perspective view of an embodiment of the mobile power system according to an aspect of this disclosure being transported by a ship.

FIG. 12 is a perspective view of the mobile power system of FIG. 11 located proximate an electric power plant.

FIG. 13 depicts an HTS connection hub according to an aspect of this disclosure.

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. Various aspects of the subject matter discussed in greater detail below may be implemented in any of numerous ways, as the subject matter is not limited to any particular manner of implementation. Examples of specific implementations and applications are provided primarily for illustrative purposes.

Unless otherwise defined, used, or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms “includes,” “including,” “comprises,” and “comprising” specify the presence of the stated elements or steps but does not preclude the presence or additional of one or more other elements or steps.

As described above, black-start service is important to the safe, reliable, and resilient operation of electric power systems and a critical part of system restoration for electric power grids. However, power generation facilities, including hydroelectric, on and off-shore wind, nuclear, coal-fired, oil-fired, solar, and natural gas-fired power plants, connected to electric grids are typically located far from the locations where the power needs to be delivered, e.g. towns, cities, large industrial complexes, military facilities. These power plants can generate 100 MW to 1+GW of power. Due to problems with the generation facilities caused by an EMP attack or a naturally occurring geomagnetic disturbance (GMD), for example, the remote power generation facility may not be operable and may not be capable of black starting the electric system. Even if a remote power generation facility could be black started, there may be inoperable electrical equipment in between the power generation facility and numerous locations needing power, thereby preventing the transmission of power to the locations needing it.

Therefore, there is a need for a mobile electric power plant that can be readily deployed to various locations on an electric system to power portions of the electrical system via connection to an electric substation or directly a power generating facility. There is a further need for such a mobile power plant, which can be used to black-start the electric power system even when the blackout is caused by an extreme electromagnetic incident. For the mobile power plant to be used in a black start operation caused by an extreme electromagnetic incident, the mobile power plant itself must be protected against EMP attacks and/or naturally occurring GMDs. In addition, the mobile power plant must be of a sufficient size to be able to power a portion if not all of the power requirements of the electric substation, which may be tens or even hundreds of megawatts.

In one aspect of this disclosure, the mobile power plant may transported to remote and isolated locations via rail transport and in another aspect of the disclosure the mobile power plant may transported to remote and isolated locations via ship transport. Although not specifically described herein, other types of transport systems are within the scope of this disclosure. It should be noted that the mobile power plant according to this disclosure may be used to provide power in the event of a natural disaster, e.g. a hurricane, which may have taken out transmission or generation facilities. The mobile power plant may be deployed after the natural disaster, but it could be deployed in advance of the disaster in cases where there the disaster is predicted far enough in advance to allow the mobile power plant to be deployed to the region of the disaster.

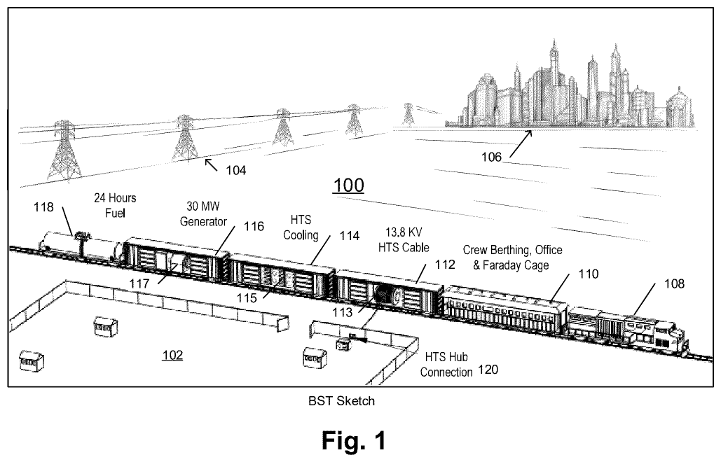

In a first embodiment shown in FIG. 1 there is depicted a mobile power plant 100 for supplying temporary electric power to an electric power system. In this example, the mobile power plant is transported by rail. The remote location requiring mobile power is depicted as an electric substation 102 that is interconnected to and powered by a high voltage transmission line 104 in order for the substation 102 to provide power to city 106. Under normal conditions, one or more remote power generation facilities generate large amounts of power and deliver the power of transmission lines to remote substations, like substation 102.

Although not shown, electric substation 102 includes electrical equipment like transformers, switchgear, circuit breakers, and associated devices. Transformers step down the high voltage electricity, typically from 69 kV to 500+kV, coming in to substation 102 on transmission line 104, to a much lower voltage, typically in the range of 4-36 kV, suitable to send out on distribution lines (not shown) leaving substation 102. The distribution lines provide distribution power to an area of a town a city or a large industrial complex, for example. In this example, the voltage of the mobile power system is 13.8 Kv, but the voltage will vary depending on the site and the equipment.

As described above, EMP or GMD may cause widespread and long-lasting damage to electric power systems and other critical infrastructure. In these cases, and in other cases where power production becomes in operable, mobile power plant 100 may be used. Mobile power plant 100 is shown to includes a plurality of cars, including a locomotive car 108 connected to and configured to pull a plurality of train cars 110, 112, 114, 116, and fuel car 118. Of course, various other types of train car configurations are possible and this is simply an example of one possible configuration.

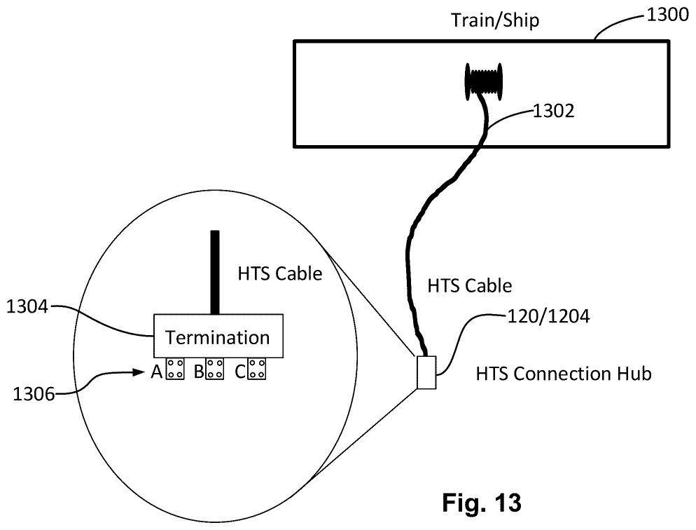

Train car 110 may include a crew berth and/or an office space. Train car 112 may include a power cable, which may be a high temperature superconductor power cable 119, Power cable 113 may be a on a spool so that the power cable 113 can be paid out and electrically interconnected to a hub connection 120 (described below with regard to FIG. 13) to provide power to the electrical substation 102 in the event that the normal electric power feed from transmission line 104, for example, is not available. Using an HTS cable instead of an ordinary power cable made of copper wire is not a requirement; however, HTS power cables are much more power dense, light, and compact as compared to typical copper power cables and are therefore preferred. For the remainder of the description we will be showing an HTS power cable, but it should be understood that a conventional power cable may be used instead.

A HTS power cable must be cooled to cryogenic temperatures in order to operate, therefore a HTS cooling system 115 configured to be in fluid communication with HTS power cable 113 may be included in train car 114. HTS cooling system 115 will provide cryogenic fluid to the HTS power cable 113 to maintain the cable at cryogenic temperatures.

In order to generate power for the mobile power system 100, there is included in train car 116 is a turbo-generator, which may include gas turbine interconnected to an electrical generator 117. The gas turbine may be fueled by fuel car 118, which includes piping (not shown) to provide the fuel to the gas turbine in order to drive rotation of the electrical generator 117 via a shaft from the gas turbine interconnected to the electrical generator. A conventional generator using copper windings may be used; however, HTS generators are much more power dense, light, and compact as compared to convention generators and are therefore preferred. Indeed, HTS generators and HTS power cables may be required in cases where the power requirements are such that a conventional generator and conventional power cable will not fit on the train cars (or other transport means). A typical turbo-generator for this application may be in the range of thirty (30) MW. For the remainder of the description we will be showing an HTS generator, but it should be understood that a conventional generator may be used instead. Both HTS power cables and HTS generators and cooling systems will be described in more detail below.

For the mobile power plant 100 to be used in a black start operation, the power plant itself must be protected against EMP attacks and/or naturally occurring GMDs. This is accomplished by enclosing the electrical and electronic components within a Faraday enclosure, such as a Faraday cage or Faraday shield to block electromagnetic fields. A Faraday shield may be formed by a continuous covering of conductive material, or in the case of a Faraday cage, by a mesh of such materials. Conductive materials such as Copper, aluminum, and Silver, may be used.

A Faraday enclosure operates because an external electrical field causes the electric charges within the cage's conducting material to be distributed so that they cancel the field's effect in the interior of the enclosure. This is used to protect sensitive electronic equipment (for example RF receivers) from external radio frequency interference (RFI). They are also used to protect people and equipment against electric currents and electrostatic discharges, since the enclosing cage conducts current around the outside of the enclosed space and none passes through the interior. The Faraday enclosures for the components in the train cars will be described in more detail below and depicted in the figures.

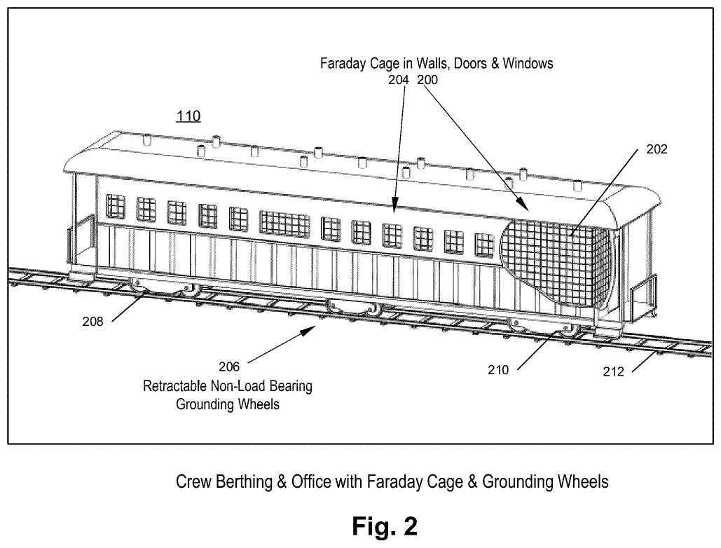

Referring now to FIG. 2, crew berthing and office car 110 is depicted to show a cut-away portion 200 of the exterior wall of the car to reveal a Faraday cage 202 embedded between the exterior wall and the interior wall of the train car to shield the interior from electrical impulses from EMP attacks and/or naturally occurring GMDs. Alternatively, the faraday cage may be mounted to the interior wall of the train car. Also shown are portions of the Faraday cage covering the windows 204 and, although not shown, they would be included in or mounted to the doors. Also included is a set of retractable non-load bearing grounding wheels 206. The grounding wheels may be retracted while the train is travelling along the tracks 212 and supported by non-retractable load bearing wheel sets 208 and 210. When the train is stationary, the retractable wheel set 206 may be extended to be in contact with the tracks 212. The retractable wheel set 206 may be connected to the Faraday cage 202 of the train car, thereby grounding Faraday cage 202 through the retractable wheels 206 and the tracks 212.

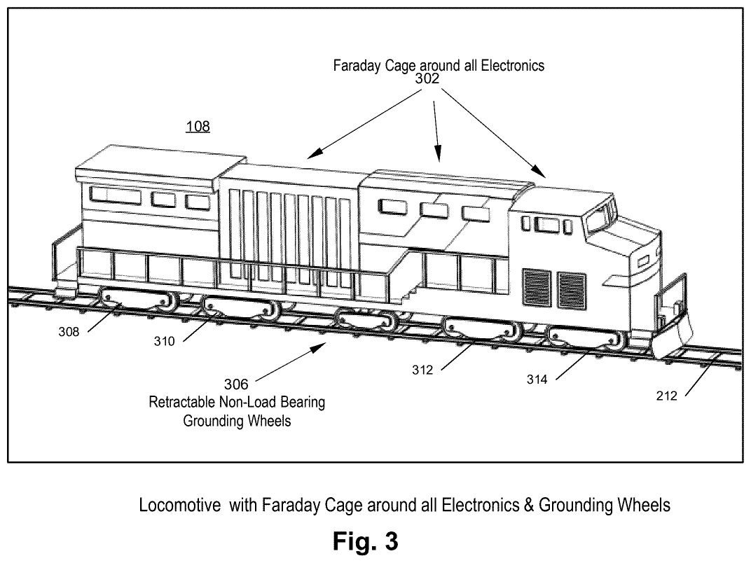

Locomotive car 108 is depicted in more detail in FIG. 3 and may also include a set of retractable non-load bearing grounding wheels 306. The grounding wheels may be retracted while the locomotive car 108 is travelling along the tracks 212 and supported by non-retractable load bearing wheel sets 308, 310, 312, and 314. When the train is stationary, the retractable wheel set 306 may be extended to be in contact with the tracks 212. The retractable wheel set 306 may be connected to the Faraday cage 302 (not visible in this view) of the locomotive car, thereby grounding Faraday cage 302 through the retractable wheels 306 and the tracks 212. Faraday cage 302 may be configured in the same manner as Faraday cage 202, FIG. 2, to cover the entire interior of the car or it may be designed to cover key portions of the locomotive including electronics and personnel.

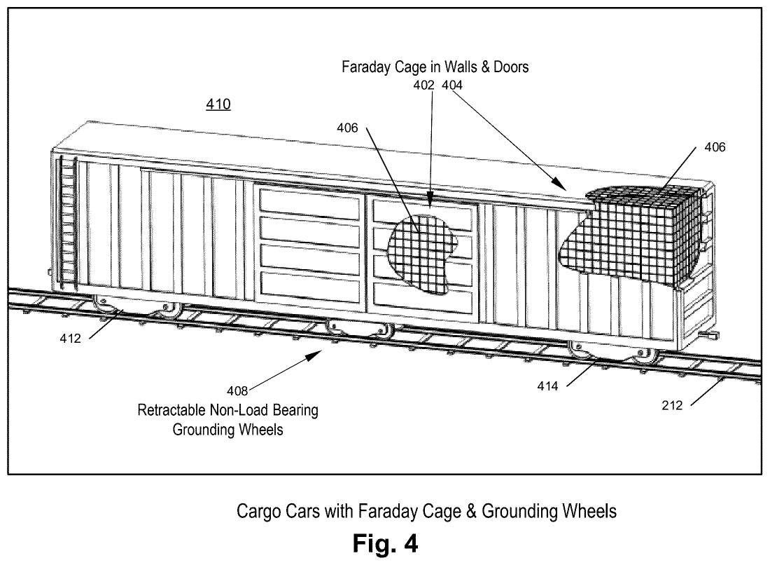

Referring now to FIG. 4, a generic cargo car 400 is depicted to show a cut-away portions 402 and 404 of the exterior wall of the car to reveal a Faraday cage 406 embedded between the exterior wall and the interior wall of the train car to shield the interior from electrical impulses from EMP attacks and/or naturally occurring GMDs. Alternatively, the faraday cage may be mounted to the interior wall of the train car. As with the crew berthing car 110 and the locomotive car 108, there included is a set of retractable non-load bearing grounding wheels 408. The grounding wheels may be retracted while the train is travelling along the tracks 212 and supported by non-retractable load bearing wheel sets 412 and 414. When the train is stationary, the retractable wheel set 408 may be extended to be in contact with the tracks 212. The retractable wheel set 408 may be connected to the Faraday cage 406 of the train car, thereby grounding Faraday cage 406 through the retractable wheels 408 and the tracks 212. The design of this generic cargo car with Faraday cage 406 and retractable wheel set 408 may be the design used for train cars 112, 114, and 116 of FIG. 1 containing, respectively, an HTS cable, an HTS cooling system, and an HTS turbo generator.

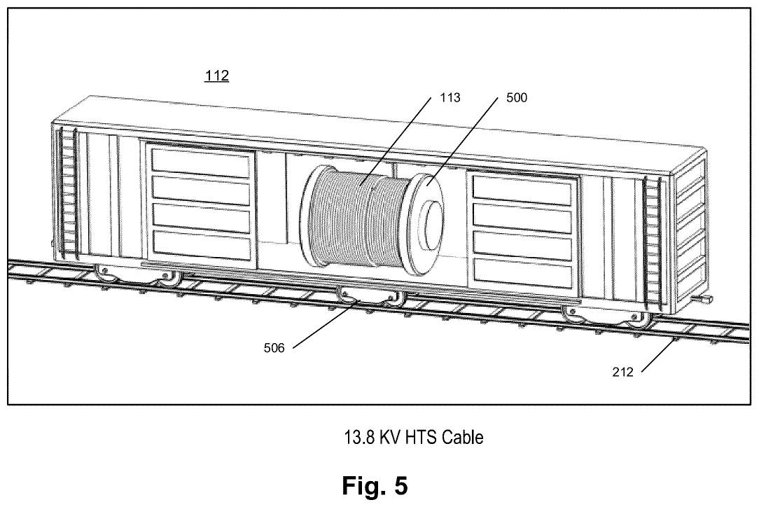

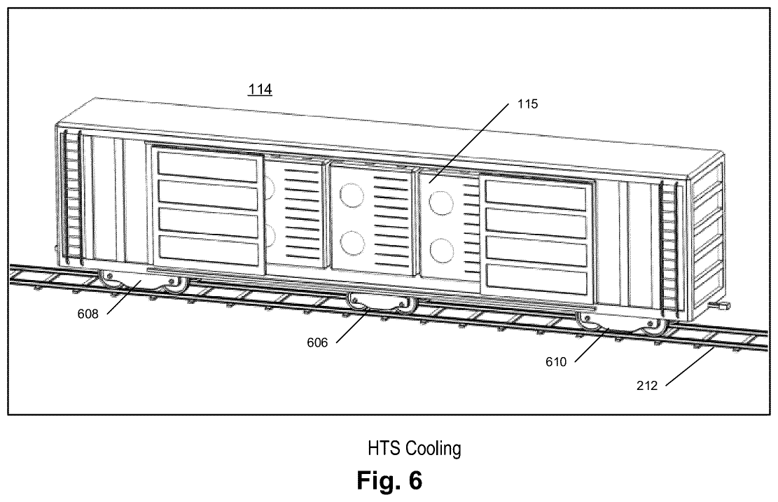

As shown in FIG. 5, train car 112 may include a power cable 113, which may be wound on spool 500 so that the power cable 113 can be paid out and electrically interconnected to a hub connection 120 to provide power to the electrical substation 102, as shown in FIG. 1. The connection of HTS power cable 113 to HTS cooling system 115 of train car 114 (FIG. 6) is not shown, but it would be apparent to one skilled in the art. Both train cars 112 and 114 will include Faraday cages (not shown) like the Faraday cage 406 of FIG. 4. Train car 112 includes retractable grounding wheel set 506 and train car 114 includes retractable grounding wheel set 606.

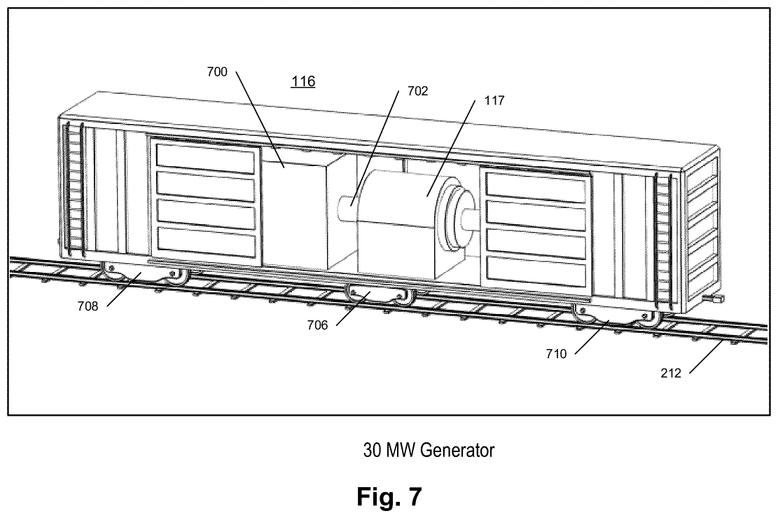

Train car 116 containing a turbo-generator is shown in more detail in FIG. 7 to include gas turbine 700 interconnected to an electrical generator 117. The gas turbine may be fueled by fuel car 118 (FIG. 1), via piping (not shown) to provide fuel to the gas turbine in order to drive rotation of the electrical generator 117 via shaft 702 from the gas turbine 700 interconnected to electrical generator 117. A typical turbo-generator for this application may be in the range of thirty (30) MW. The piping of fuel between fuel car 118 and gas turbine 700 of train car 116 is not shown nor is the electrical connection from the electrical generator 117 of train car 116 to the HTS power cable 113 of train car 114. However, the piping and electrical connections between these components will be apparent to one skilled in the art.

Train cars 114 and 116 includes retractable grounding wheel sets 606 and 706, respectively. Train car 114 also includes non-retractable load bearing wheel sets 608 610 and train car 116 also includes non-retractable load bearing wheel sets 708 and 710.

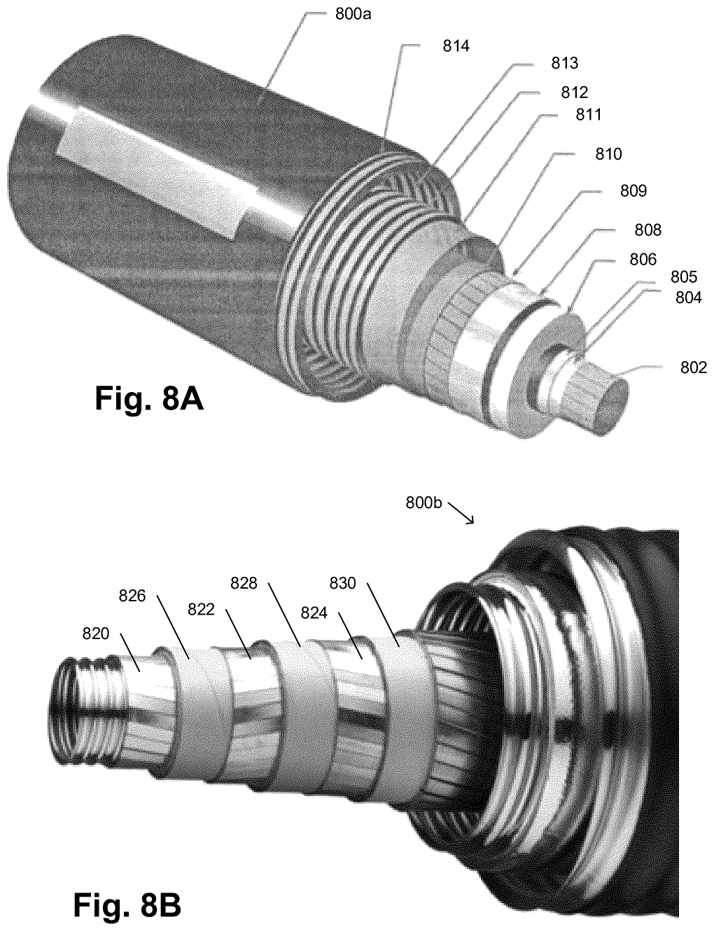

Described below and shown in FIGS. 8-11 are exemplary HTS power cables (single-phase and three-phase) and an HTS generator, which may be used in the mobile power system described herein. A single-phase HTS power cable design is described in more detail in U.S. Pat. No. 7,304,826, which is hereby incorporated herein in its entirety. A three-phase power cable design is described in U.S. Pat. Nos. 8,326,386 and 8,623,787, both of which are also hereby incorporated herein in its entirety. It should be noted these cable designs or any other suitable HTS power cable design may be used in connection with the mobile power system according to this disclosure.

The HTS generator design is described in more detail in U.S. Pat. No. 10,601,299, which is hereby incorporated herein in its entirety. This generator is a low inertia HTS generator; however, it should be noted that any suitable HTS power cable and/or HTS generator design may be used in connection with the mobile power system according to this disclosure.

### HTS Power Cable

Referring to FIG. 8A, a portion of a single phase HTS cable 800a includes a strand copper core 802 surrounded in radial succession by a first high temperature superconductor layer 804, a second high temperature superconductor layer 805, a high voltage insulation layer 806, a high temperature superconductor shield layer 808, an outer copper shield layer 809, a protection layer 810, a coolant envelope 811, an inner cryostat wall 812, a vacuum space 813, an outer cryostat wall 814 and an outer cable sheath 815.

In operation, a refrigerant (e.g., liquid nitrogen) is supplied from an external coolant source (HTS cooling system 115, FIGS. 1 and 6) to circulate inside and along the length of coolant envelop 811.

Three separate single-phase cables 800a would be combined to provide three-phase power required in a typical electrical system. Alternatively, a single three-phase cable 800b, as shown in FIG. 8B may be used. Here, the three HTS phases 820, 822, and 824 are included in a single system separated by insulating layers 826, 828, and 830, respectively.

These single-phase and three-phase HTS power cables are available from Nexans, Paris France. Other companies, such as Sumitomo Electric Industries, Ltd., Osaka, Japan and nkt cables, Asnaes Denmark may also produce HTS power cables like this.

### HTS Turbo Generator

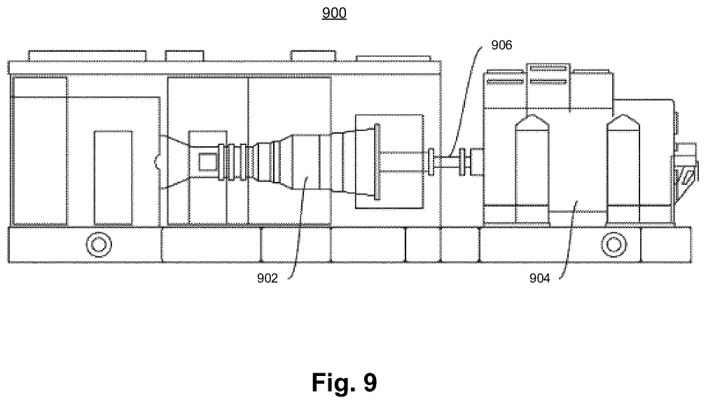

In FIG. 9, there is shown turbo-generator 900 having gas turbine 902, which may rotate at high rpm and drive a HTS generator 904 via shaft 906. In this example, HTS generator 904 may be a 30 MW 3600 rpm 2 pole generator designed to operate at 60 Hz and designed to be powered by a 30 MW gas-turbine 902. However, this disclosure is not limited to any particular generator or gas-turbine power level, pole count or configuration and is applicable to various gas turbine systems.

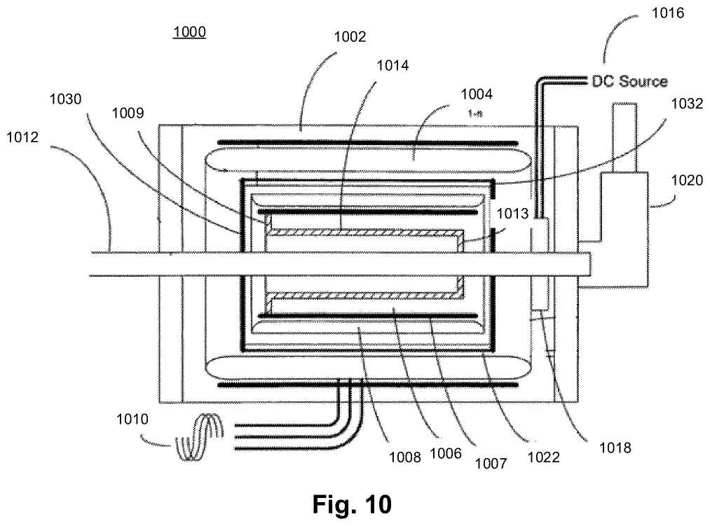

Referring to FIG. 10, there is shown a prior art HTS generator 1000, which may be used as the HTS generator 902 of FIG. 9. HTS generator 1000 may be designed as a low inertia generator to be optimized for minimum size and weight. HTS generator 1000 may include a stator assembly 1002 having stator coil assemblies 1004.sub.1-n. As is well known in the art, the specific number of stator coil assemblies 1004₁₋ₙ included within stator assembly 1002 varies depending on various design criteria, such as whether the machine is a single phase or a polyphase machine.

A rotor assembly 1006 rotates within stator assembly 1002. As with stator assembly 1002, rotor assembly 1006 includes rotor winding assemblies 1008₁₋ₙ. The rotor winding assemblies 1008 may be in a saddle coil configuration, as they are well suited to high rpm generator applications. These rotor winding assemblies, during operation, generate a magnetic flux that links rotor assembly 1006 and stator assembly 1002. While this generator is designed as a two-pole machine, it will be understood by those skilled in the art that various pole count machines could be used and the particular design will be dependent upon the application.

During operation of generator 1000, a three-phase voltage 1010 is generated in stator coil assemblies 1004₁₋ₙ which, in turn, is output to the HTS power cable 113 (FIGS. 1 and 5). The three-phase voltage in the stator coil assemblies 1004₁₋ₙ, is produced by the rotor winding magnetic flux generated by the rotor coil assemblies 1008₁₋ₙ that links rotor assembly 1006 and stator assembly 1002, as the rotor rotates when driven by turbo-generator shaft 1012.

The rotor winding assemblies 1008₁₋ₙ may be mounted on an outside surface of support structure 1007, which is connected to a first flange 1009 that transfers the torque from torque tube 1014. It should be noted that the rotor winding assemblies 1008₁₋ₙ may, alternatively, be mounted on an inside surface support structure 1007. Torque tube 1014 is connected to a second flange 1013, which is connected to turbo-generator shaft 1012. Flanges 1009 and 1013 may be incorporated into torque tube 1014 or may be separate assemblies. Of course, other torque tube designs may be used to transfer the torque from the shaft 1012 to the rotor assembly in the cold space.

During operation of superconducting rotating machine 1000, field energy 1016, for example, from a DC current source (not shown) may be applied to rotor winding assembly 1008₁₋ₙ through a slip ring/rotating disk assembly 1018. Rotor winding assemblies 1008₁₋ₙ require DC current to generate the magnetic field (and the magnetic flux) required to link the rotor assembly 1006 and stator assembly 1002.

Stator coil assemblies 1004₁₋ₙ are formed of non-superconducting copper coil assemblies, for example, while rotor winding assemblies 1008₁₋ₙ are superconducting assemblies incorporating HTS windings. Examples of HTS conductors include: thallium-barium-calcium-copper-oxide; bismuth-strontium-calcium-copper-oxide; mercury-barium-calcium-copper-oxide; and yttrium-barium-copper-oxide.

As these superconducting conductors only achieve their superconducting characteristics when operating at low temperatures, HTS generator 1000 includes a refrigeration system 1020. Refrigeration system 1020 is typically in the form of a cryogenic cooler that maintains the operating temperature of rotor winding assemblies 1008₁₋ₙ at an operating temperature sufficiently low to enable the conductors to exhibit their superconducting characteristics. Since rotor winding assemblies 1008₁₋ₙ must be kept cool by refrigeration system 1020, torque tube 1014 may be constructed from a high strength, low thermal conductivity metallic material (such as Inconel™) or composite material (such as G-10 phenolic or woven-glass epoxy).

Rotor assembly 1006 includes an electromagnetic shield 1022 positioned between stator assembly 1002 and rotor assembly 1006 to shield or filter asynchronous fields from harmonics produced in the stator assembly 1002. As rotor assembly 1006 is typically cylindrical in shape, electromagnetic shield 1022 is also typically cylindrical in shape. It is desirable to shield the rotor winding assemblies 1008₁₋ₙ of rotor assembly 1006 from these asynchronous fields. Accordingly, electromagnetic shield 1022, which is fitted to rotor assembly 1006, covers (or shields) rotor winding assemblies 1008₁₋ₙ from the asynchronous fields and is constructed of a non-magnetic material (e.g., copper, aluminum, etc.). The electromagnetic shield 1022 should be of a length sufficient to fully cover and shield rotor winding assemblies 1008₁₋ₙ. The case considered so far is steel and a thin overcoat of copper with the thicknesses selected to shield ac fields and withstand fault loads. Aluminum is lightest solution but steel could be selected if weight is of less interest than cost. The shield also provides vacuum containment and steel presents a simpler sealing solution with welding.

The electromagnetic shield 1022 may be rigidly connected to shaft 1012 via a pair of end plates 1030, 1032. This rigid connection can be in the form of a weld or a mechanical fastener system (e.g., bolts, rivets, splines, keyways, etc.). For shielding, the thickness of electromagnetic shield 1022 varies inversely with respect to the frequency of the three-phase AC power 1010, which in this example is 60 Hertz. For low pole count designs the thickness may be selected to withstand transient forces during fault. For this frequency, typically, the thickness of electromagnetic shield 1022 would be no more than 10 cm (4 in) of steel and copper.

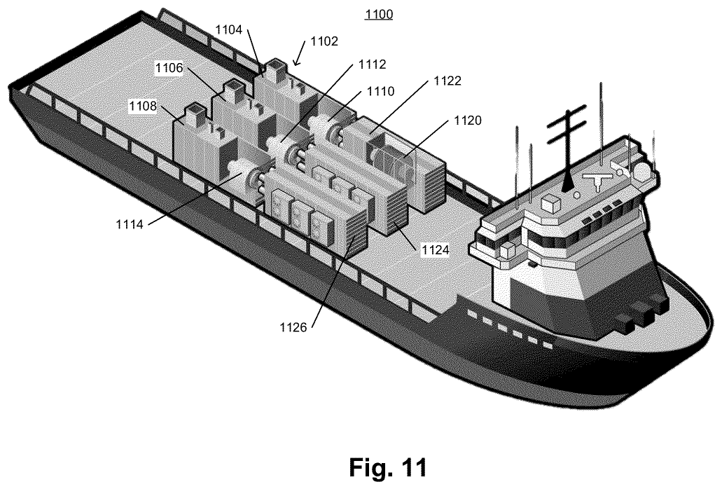

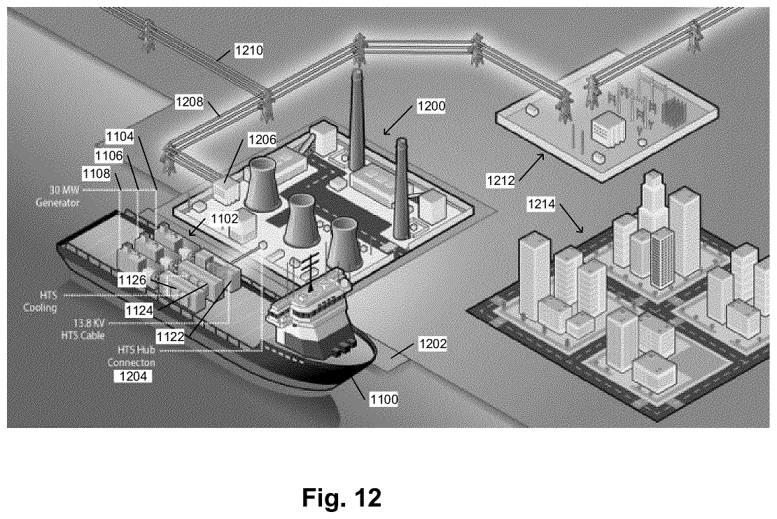

In another application, instead of train cars, shipping containers having Faraday enclosures could be used to contain the HTS cable, HTS generator, cooling system, and other equipment, as desired. These containers may be loaded onto a ship as depicted in that could be deployed to a dock adjacent to a substation or a power generation facility as depicted in FIGS. 11 and 12. The faraday enclosures would need to be connected to ship's ground which is the hull of the ship.

Ship 1100 may include on its deck (or stored elsewhere) a mobile power plant 1102 according to another aspect of this disclosure. Mobile power plant 1102, in this example, is depicted to include three 30 MW turbo generators 1104, 1106, and 1108, which may be stored inside cargo containers for a total of 90 MW of mobile power. The 90 MW of power is a typical power level required for power generation facility. In contrast, the power required for substation, such as depicted in FIG. 1, may be approximately 30 MW. The turbo-generators include gas turbines, which may rotate at high rpm and each drive a HTS generator (1110, 1112, 1114), just as those depicted in FIG. 9 and described above. However, this disclosure is not limited to any particular generator or gas-turbine power level, pole count or configuration and is applicable to various gas turbine systems. The gas turbines may be fueled by the fuel used to power ship 1100 or a separate dedicated fuel supply may be provided.

Depicted in phantom in FIG. 11, turbo generators 1104, 1106, and 1108 may be stored inside cargo containers. While not depicted in this figure, the cargo containers may include Faraday cages built into the walls thereof, like the train cars described above to protect the equipment from EMPs/GMDs, which may cause widespread and long-lasting damage to electric power systems and other critical infrastructure.

The electrical output of the HTS generators 1110, 1112, 1114 may be connected to an HTS power cable 1120 mounted within cargo container 1122. HTS power cable 1120 in this example is a 13.8 KV power cable, which may be paid out once the ship has arrived at the location that the mobile power plant 1102 is needed. The HTS cryogenic cooling system is contained in cargo containers 1124 and 1126 may be interconnected to HTS cable 1120 to provide cryogenic cooling for the HTS cable to operate in a superconducting state. The power for the cryogenic cooling system may be provided by the ship's on board electrical power network.

Once ship 1100 has arrived at its destination, in this case at power generation facility 1200, FIG. 12, it may be secured to dock 1202 and the mobile power plant 1102 may be electrically connected to HTS connection hub 1204 by power cable 1122. Through connection hub 1204, the power from HTS cable 1122 may be fed to step-up transformer 1206 to step up the 13.8 KV voltage to transmission level voltage (i.e. 69 kV to 500+kV) and output the power on transmission line 1208. Transmission line 1208 may provide power over transmission line 1210 to a remote substations and it may power local substation 1212 which steps the transmission line voltage down to a distribution level voltage (i.e. 4-36 kV) to power, for example, city 1214.

HTS connection hub 1204 (as well as HTS connection hub 120, FIG. 1) is shown in more detail in FIG. 13. The HTS cable 1302 is shown on a train/ship 1300 and is interconnected to HTS connection hub 120/1204, which comprises an HTS termination 1304 for receiving HTS cable 1302 and convention three-phase connectors 1306 (A,B,C), which may comprise NEMA 4-hole pad bolted connectors to which may be attached conventional copper aluminum cables. Termination may be of the type described in U.S. Pat. Nos. 8,633,381 and 10,050,430 or any other suitable HTS termination.

It should be noted that termination may be brought to the site by the train and/or ship and placed at the site when the HTS cable is connected to the connection hub or it may be located on site.

We have described herein a mobile power plant, which can be moved/transported to a remote location to power a portion of an electrical system. The two methods of transportation described herein are a train and a ship. While these are the most likely candidates to be used with the mobile power system, the intent that the mobile power system may be used with any vehicle, i.e. any machine designed for self-propulsion, usually to transport people or cargo, or both.

Moreover, the containers to enclose components (e.g. turbo generator, power cable, and cooling) of the mobile power system herein are described as train cars for train applications and containers for the ship applications. We may generally refer to containers for enclosing the components of the mobile power system and this should be interpreted to include any type of container, including containers used to transport cargo on ships, train cars, or any other suitable type of container.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A mobile power system configured to be transported on a vehicle for supplying temporary electric power to a remote electric power system, the mobile power system comprising:
A plurality of containers configured to be transported on the vehicle;
A power generator contained in a faraday enclosure in a first container of the plurality of containers; and
A power cable configured to be electrically interconnected to the power generator at a first end and configured to be electrically interconnected to the electric power system at a second end; the power cable contained in a faraday enclosure of a second container of the plurality of containers.

2. The mobile power system of claim 1 wherein the power generator is a high temperature superconductor (HTS) generator.

3. The mobile power system of claim 2 wherein the power cable is a HTS power cable.

4. The mobile power plant of claim 3 wherein the plurality of containers include a third container in which is included a cryogenic cooling system contained in a third faraday enclosure; the cryogenic cooling system configured to be fluidly coupled to the HTS power cable and to circulate a cooling fluid in the HTS power cable.

5. The mobile power plant of claim 4 wherein the plurality of containers includes a fourth container having a fuel tank configured to be fluidly coupled to a turbine in the second container to supply fuel to the turbine; the turbine contained in the third faraday enclosure and mechanically coupled to the HTS generator.

6. The mobile power plant of claim 1 wherein the vehicle is one of a train or a ship.

7. A mobile power system for supplying temporary electric power to an electric power system, the mobile power system comprising:
A plurality of train cars;
A locomotive car configured to be interconnected to and propel the plurality of train cars;
A power generator contained in a faraday enclosure in a first car of the plurality of train cars; and
A power cable configured to be electrically interconnected to the power generator at a first end and configured to be electrically interconnected to the electric power system at a second end; the power cable contained in a faraday enclosure of a second car of the plurality of train cars.

8. The mobile power plant of claim 7 wherein the power generator is a high temperature superconductor (HTS) generator.

9. The mobile power plant of claim 8 wherein the power cable is a HTS power cable.

10. The mobile power plant of claim 9 wherein the plurality of train cars includes a third car in which is included a cryogenic cooling system contained in a third faraday enclosure; the cryogenic cooling system configured to be fluidly coupled to the HTS power cable and to circulate a cooling fluid in the HTS power cable.

11. The mobile power plant of claim 10 wherein the plurality of train cars includes a fourth car containing a fuel tank configured to be fluidly coupled to a turbine in the second car to supply fuel to the turbine; the turbine contained in the third faraday enclosure and mechanically coupled to the HTS generator.

12. The mobile power plant of claim 11 wherein the locomotive car includes at least one electronic component contained in a fourth faraday enclosure.

13. The mobile power plant of claim 12 further including a fifth car of the plurality of train cars, the fifth car including a work area for at least one crew member and including at least one electronic component contained in a fifth faraday enclosure.

14. The mobile power plant of claim 13 wherein each of the first, second, third, fourth, and fifth faraday enclosures include four walls, a ceiling, and a floor and wherein one or more of the first, second, third, fourth, and fifth faraday enclosures have the four walls, ceiling, and floor integrated into four walls, ceiling, and floor of its respecting train car.

15. The mobile power plant of claim 9 wherein the HTS power cable is on a spool and is configured to be unwound to connect the HTS power cable to an electrical connector of a substation of the electric power system.

16. The mobile power plant of claim 13 wherein one or more of the first, second, third, fourth, and fifth train cars include a set of grounding wheels configured to contact the train tracks.

17. The mobile power plant of claim 16 wherein each set of grounding wheels is retractable and non-load bearing.

18. The mobile power plant of claim 16 each train car with a set of grounding wheels further includes a plurality of sets of load bearing wheels.
